(19) United States
(12) Patent Application Publication
(10) Pub. No.: US 2024/0146109 A1
(43) Pub. Date: May 2, 2024

(54) WIRELESS POWER APPARATUS, CHARGING DOCK AND ELECTRONIC EQUIPMENT

(71) Applicant: Luxshare Precision Industry Company Limited, SHENZHEN (CN)

(72) Inventors: Kuan Ying HO, SHENZHEN (CN); Chih Yung WU, SHENZHEN (CN); Yu Pei HUANG, SHENZHEN (CN); Yao Nien CHUNG, SHENZHEN (CN); Pei Shan LI, SHENZHEN (CN)

(73) Assignee: Luxshare Precision Industry Company Limited, SHENZHEN (CN)

(21) Appl. No.: 18/379,572

(22) Filed: Oct. 12, 2023

(30) Foreign Application Priority Data
Oct. 26, 2022 (CN) 202211320976.8

(51) Int. Cl. H02J 50/10; H02J 50/00

(52) U.S. Cl. CPC H02J 50/10; H02J 50/005

(57) ABSTRACT

Provided are a wireless power apparatus, a charging dock and an electronic equipment. In the wireless power apparatus, a housing is provided with a mounting cavity; a first battery is disposed within the mounting cavity; multiple first magnetic pieces are disposed in the housing and are configured for adsorbing multiple first adsorption pieces of an equipment body, respectively; a first charging assembly is configured to charge the first battery, a wireless power supply assembly is disposed within the mounting cavity, is electrically connected to the first battery, and is capable of transmitting power of the first battery to the equipment body.

### CROSS-REFERENCE TO RELATED APPLICATIONS

This application claims priority to Chinese Patent Application No. 2022113209768 filed Oct. 26, 2022, the disclosure of which is incorporated herein by reference in its entirety.

### TECHNICAL FIELD

The present disclosure relates to the technical field of power banks and, in particular, to a wireless power apparatus, a charging dock and an electronic equipment.

### BACKGROUND

In a process of the outdoor activity (e.g., an activity holding in a natural venue), people would carry a wide variety of electronic equipment, such as a communication device, a lighting device, a cookware and a fan, without limitation, to satisfy various needs in the outdoor, and for a normal operation of the above-described devices, most devices have a battery.

Under a condition that various devices have the battery, each device has a large mass and it is inconvenience of portability. In addition, electronic equipment that have batteries are bulky, require a larger volume to accommodate, and finally, the electronic equipment needs to be suspended for charging when they run out of electricity, thereby resulting in inconvenience of use.

The above-described problems can be solved to some extent by an existing power bank. However, the power bank is connected to the electronic equipment through a transmission line, whereby a large number of parts results in inconvenience of use. In addition, the power bank and the electronic equipment cannot be fixed together to form an integrated structure, so that the power bank and the electronic equipment have a large footprint during use.

### SUMMARY

The present disclosure provides a wireless power apparatus, a charging dock and an electronic equipment, so as to solve a problem existing in the related art that the power bank and the electronic equipment need to be connected through the transmission line, resulting in inconvenient use, and the power bank and the electronic equipment cannot be connected together, resulting in the large footprint during use.

To achieve the above objectives, the present disclosure adopts following technical schemes.

Ina first aspect, the present disclosure provides a wireless power apparatus. The wireless power apparatus includes a housing, a first battery, multiple first magnetic pieces, a first charging assembly and a wireless power supply assembly. The housing is provided with a mounting cavity. The first battery is disposed within the mounting cavity. The multiple first magnetic pieces are disposed in the housing. The first charging assembly is configured to charge the first battery. The wireless power supply assembly is disposed within the mounting cavity and electrically connected to the first battery.

In an embodiment, an upper end surface of the housing includes a first adsorption portion and a power supply portion, the first adsorption portion is located at an outer periphery of the power supply portion, the wireless power supply assembly is disposed on the power supply portion, and the multiple first magnetic pieces are dispersedly disposed on the first adsorption portion.

In an embodiment, a lower end of the housing is provided with a second magnetic piece, the second magnetic piece is provided with multiple second magnetic pieces, and in a case where two housings are stacked, second magnetic pieces on an upper housing are capable of being adsorbed to first magnetic pieces on a lower housing correspondingly.

In an embodiment, multiple first batteries are connected in series in a case where multiple housings are stacked.

In an embodiment, the lower end of the housing includes a second adsorption portion and a charging portion, the second adsorption portion is located at an outer periphery of the charging portion, the first charging assembly is disposed on the charging portion, and the multiple second magnetic pieces are dispersedly disposed on the second adsorption portion.

In an embodiment, the first adsorption portion has a structure of a conical surface; or the first adsorption portion has a structure of a conical surface, and the second adsorption portion is parallel to the first adsorption portion.

In a second aspect, the present disclosure provides a charging dock. The charging dock is configured to charge the wireless power apparatus of any one of the above-described items, a lower end of the housing of the wireless power apparatus is provided with a second magnetic piece, the charging dock includes a base and a second charging assembly, where the base is provided with a second adsorption piece capable of being adsorbed to the second magnetic piece, and the second charging assembly is capable of charging the first battery in cooperation with the first charging assembly.

In an embodiment, a surface of the base that abuts the wireless power apparatus includes a power portion and an abutment portion, the abutment portion is disposed around an outer periphery of the power portion, the abutment portion has a structure of a conical surface; and a lower end surface of the housing is shaped to fit the base.

In a third aspect, the present disclosure provides an electronic equipment. The electronic equipment includes the wireless power apparatus of any one of the above items and an equipment body, where the equipment body is provided with a first adsorption piece capable of being adsorbed to a first magnetic piece of the wireless power apparatus, and the first battery is capable of powering the equipment body through the wireless power supply assembly.

In an embodiment, the equipment body includes a second battery and an electronic device, where the second battery is configured for powering the electronic device, the first battery is capable of powering at least one of the second battery or the electronic device through the wireless power supply assembly.

### BRIEF DESCRIPTION OF DRAWINGS

FIG. 1 is a structure view of a wireless power apparatus according to an embodiment of the present disclosure from a first perspective:

FIG. 2 is a structure view of a wireless power apparatus according to an embodiment of the present disclosure from a second perspective;

FIG. 3 is a view of an internal structure of a wireless power apparatus according to an embodiment of the present disclosure;

FIG. 4 is a view of a longitudinal sectional structure of a wireless power apparatus according to an embodiment of the present disclosure:

FIG. 5 is a view of a transverse sectional structure of a wireless power apparatus according to an embodiment of the present disclosure:

FIG. 6 is a structure view of a charging dock according to an embodiment of the present disclosure;

FIG. 7 is a view of an internal structure of a charging dock according to an embodiment of the present disclosure;

FIG. 8 is a structure view of a wireless power apparatus and a charging dock according to an embodiment of the present disclosure;

FIG. 9 is a structure view of an equipment body (fan) according to an embodiment of the present disclosure:

FIG. 10 is a structure view of an equipment body (mobile phone) and a wireless power apparatus according to an embodiment of the present disclosure; and

FIG. 11 is a structure view of an equipment body (lighting device) and a wireless power apparatus according to an embodiment of the present disclosure.

231, Positive charging terminal; 232, Negative charging terminal; 240, Second adsorption piece; 250, Power light;
300, Electronic equipment; 310, Equipment body; 320, First adsorption piece; 330, Wireless receiving coil.

### REFERENCE LIST

100 wireless power apparatus
110 housing
111 first adsorption portion
112 power supply portion
113 second adsorption portion
114 charging portion
115 mounting cavity
120 first battery
130 first magnetic piece
140 first charging assembly
141 positive terminal
142 negative terminal
150 wireless power supply assembly
160 second magnetic piece
170 operation portion
180 magnetic ring
200 charging dock
210 base
211 power supply portion
212 abutment portion
220 power line
230 second charging assembly
231 positive charging terminal
232 negative charging terminal
240 second adsorption piece
250 power light
300 electronic equipment
310 equipment body;
320 first adsorption piece
330 wireless receiving coil

### DETAILED DESCRIPTION

The technical schemes of the present disclosure will now be clearly and fully described in conjunction with the accompanying drawings. Apparently, the described embodiments are merely part of embodiments of the present disclosure, rather than all of the embodiments of the present disclosure.

In the description of the present disclosure, it should be noted that orientations or position relations indicated by terms such as “center”, “upper”, “lower”, “left”. “right”. “vertical”. “horizontal”, “inner” and “outer” are based on orientations or position relations shown in the drawings. These orientations or position relations are intended only to facilitate and simplify the description of the present disclosure and not to indicate or imply that an apparatus or element referred to must have such particular orientations or must be configured or operated in such particular orientations. Thus, these orientations or position relations are not to be construed as limiting the present disclosure. Moreover, terms such as “first” and “second” are used only for the purpose of description and are not to be construed as indicating or implying relative importance. Terms such as “first position” and “second position” are two different positions, and a first feature being “on”, “above” and “over” a second feature includes the first feature being directly above and obliquely above the second feature, or simply indicates that the first feature is at a higher level than the second feature. The first feature being “under”, “below” and “beneath” the second feature includes the first feature being directly below and obliquely below the second feature, or simply indicates that the first feature is at a lower level than the second feature.

In the description of the present disclosure, it should be noted that terms “mounted”. “joined” and “connected” are to be understood in a broad sense unless otherwise expressly specified and limited. For example, the term “connected” may refer to “fixedly connected” or “detachably connected” or “integrally connected”, may refer to “mechanically connected” or “electrically connected” or may refer to “connected directly”, “connected indirectly through an intermediary” or “connected inside two components”. For those of ordinary skill in the art, specific meanings of the preceding terms in the present disclosure may be understood based on specific situations.

The embodiments of the present disclosure will be described in detail below, examples of the described embodiments are shown in the accompanying drawings, where same or similar reference numerals refer to same or similar elements or elements having same or similar functions throughout. The embodiments described below with reference to the accompanying drawings are exemplary, merely serve to explain the present disclosure, and are not to be construed as limiting the present disclosure.

### Embodiment One

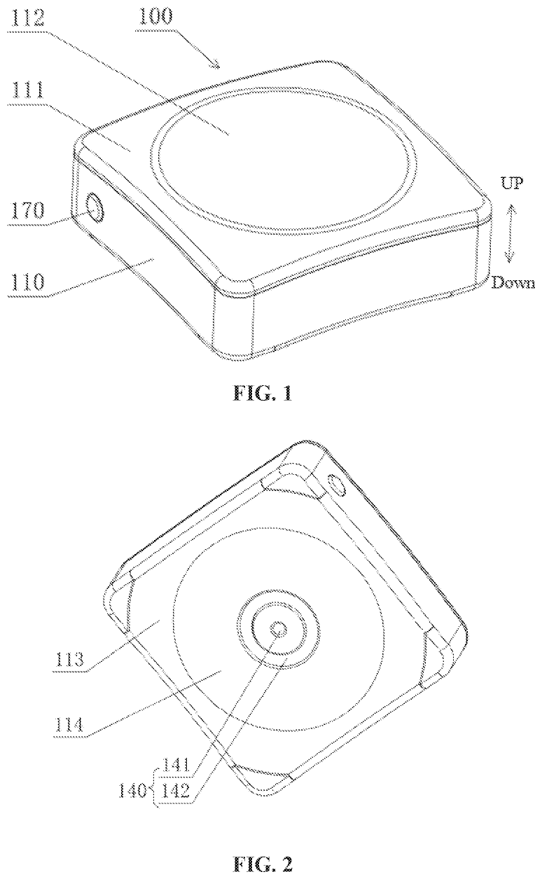

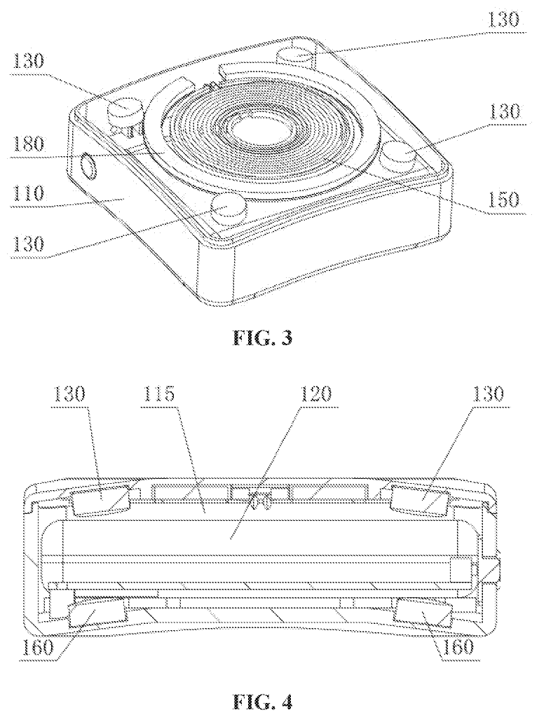

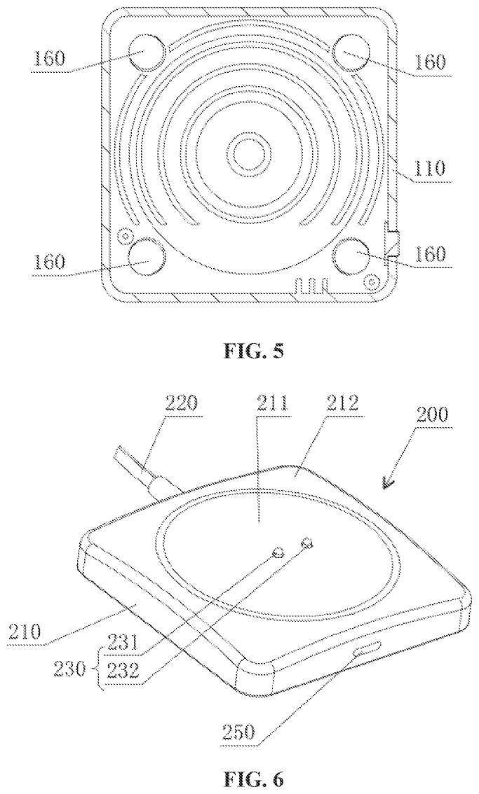

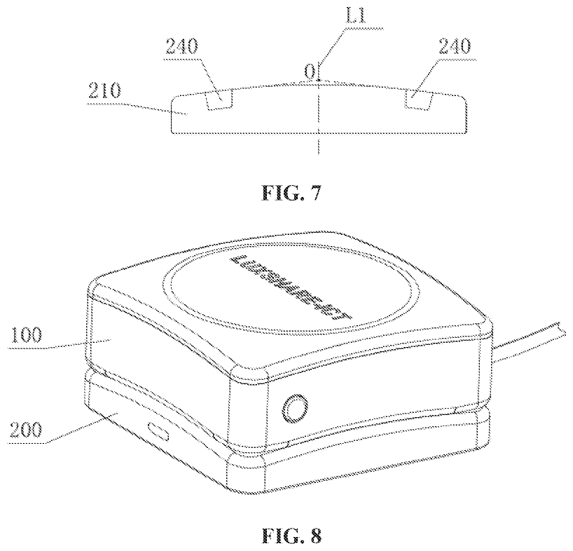

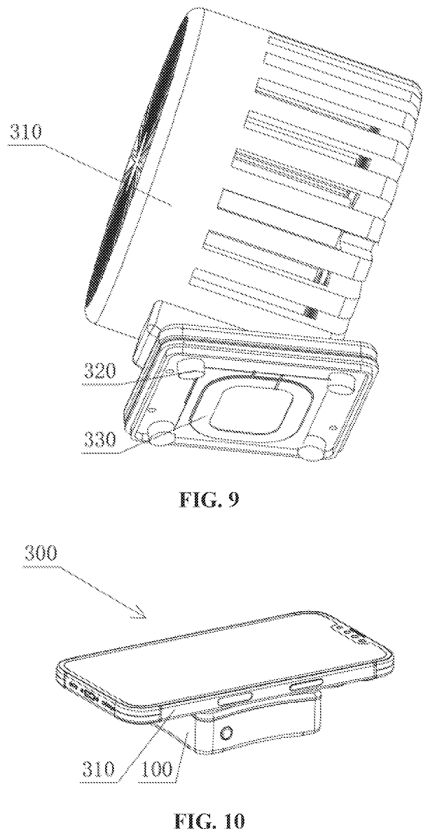

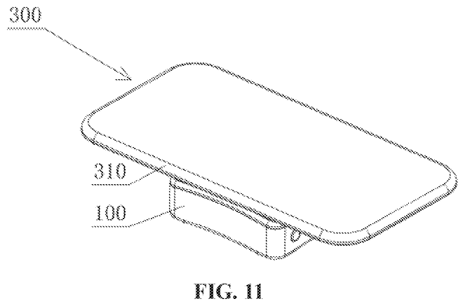

Embodiments of FIGS. 1 to 11 provide a wireless power apparatus 100. The wireless power apparatus 100 includes a housing 110, a first battery 120, a first magnetic piece 130, a first charging assembly 140 and a wireless power supply assembly 150. The housing 110 is provided with a mounting cavity 115, the first battery 120 is disposed within the mounting cavity 115; the first magnetic piece 130 is disposed in the housing 110 and is used for adsorbing a first adsorption piece 320 on an equipment body 310; the first charging assembly 140 is connectable to a power grid and is used for charging the first battery 120; the first charging assembly 140 includes a positive terminal 141 and a negative terminal 142, the positive terminal 141 and the negative terminal 142 each partially extend out of the mounting cavity 115; the wireless power supply assembly 150 is disposed within the mounting cavity 115, is electrically connected to the first battery 120, and can transmit power from the first battery 120 to the equipment body 310. The equipment body 310 may be a communication device, a lighting device, a cooker, and the like, which is not limited herein. It should be noted that, a structure of the wireless power supply assembly 150 mainly includes a wireless magneto-electric induction assembly, to enable the wireless powering or charging of the equipment body 310. A principle of the wireless charging is that energy is conducted to the equipment body 310 by a wireless charging device through a near-field induction, and the equipment body 310 converts the received energy into an electric energy, and stores the electric energy in a battery of the device or directly uses the electric energy. Conduction of energy employs a principle of inductive coupling, ensuring no exposed conductive interface and eliminating cluttered transmission lines between devices. In this embodiment, the equipment body 310 is provided with a wireless receiving coil 330, and the wireless receiving coil 330 and the wireless power supply assembly 150 cooperate to transmit the power of the first battery 120 to the equipment body 310, which may specifically refer to QI charging techniques. In this embodiment, one of the positive terminal 141 and the negative terminal 142 includes a ring-shaped connecting tab, and the other of the positive terminal 141 and the negative terminal 142 is disposed at the center of the ring-shaped connecting tab. In an example, the negative terminal 142 includes a ring-shaped connecting tab as shown in FIG. 2.

In the wireless power apparatus 100, the first magnetic piece 130 is disposed on the housing 110 so that the equipment body 310 can be adsorbed to the housing. In this manner, the use of the transmission line between the wireless power apparatus 100 and the equipment body 310 is avoided, a number of parts is reduced, and the use is more convenient. In a second aspect, the wireless power source 100 and the equipment body 310 can be connected to be an integrated structure, so that the footprint during use is reduced. In a third aspect, the apparatus charges the equipment body 310 through the wireless power supply assembly 150, avoiding an opening penetrating through the housing 110 for the wireless power supply assembly 150, so that the sealing performance of the wireless power apparatus 100 is improved and a better waterproofing is obtained.

It is known that when two objects are directly pulled in a direction of an adsorption force in a state of magnetic adsorption, the adsorption force needs to be overcome, and the two objects are difficult to separate from each other. In this embodiment, an upper end surface of the housing 110 includes a first adsorption portion 111 and a power supply portion 112, the first adsorption portion 111 is located at an outer periphery of the power supply portion 112, the wireless power supply assembly 150 is disposed on the power supply portion 112, multiple first magnetic pieces 130 are provided, and the multiple first magnetic pieces 130 are dispersedly disposed on the first adsorption portion 111, the multiple first magnetic pieces 130 may be in one-to-one correspondence with the multiple first adsorption pieces 320 on the equipment body 310. The arrangement of the multiple first magnetic pieces 130 allows a greater adsorption force when the multiple first magnetic pieces 130 are adsorbed to the multiple first adsorption pieces 320 on the equipment body 310. In addition, the arrangement of the multiple first magnetic pieces 130 and the multiple first adsorption pieces 320 allows an accurate alignment of the housing 110 with the equipment body 310. When the equipment body 310 needs to be separated from the housing 110, the wireless power apparatus 100 simply needs to be screwed relative to the equipment body 310. The multiple first magnetic pieces 130 are uniformly dispersed around the power supply portion 112, which makes alignment of the equipment body 310 with the wireless power apparatus 100 simpler. After roughly aligning the equipment body 310 with the wireless power apparatus 100, alignment of the equipment body 310 with the wireless power apparatus 100 can be achieved through the adsorption of the multiple first magnetic pieces 130 and the multiple first adsorption pieces 320. The first magnetic piece 130 may be a magnet, and the first adsorption piece 320 may be a magnet or may be a material capable of being adsorbed by a magnet.

In this embodiment, a magnetic ring 180 is mounted within the housing 110, the magnetic ring 180 can be adsorbed to and aligned with a ring-shaped adsorption piece of the equipment body 310, and a specific structure may refer to an Magsafe structure.

To save space when multiple wireless power apparatuses 100 are in storage, in this embodiment, a lower end of the housing 110 is provided with multiple second magnetic pieces 160, so that when two housings 110 are stacked, the second magnetic pieces 160 on the upper housing 110 may be adsorbed to the first magnetic pieces 130 of the lower housing 110.

In this embodiment, when multiple housings 110 are stacked, first batteries of the wireless power apparatuses 100 are connected in series, so that a voltage provided outwardly is increased. Specifically, the connection may be made by a wireless induction technology or a contact. With regard to the manner of the connection by the contact, specifically, the upper end and the lower end of the housing 110 are each provided with a positive contact and a negative contact, and when two wireless power apparatuses 100 are stacked, one of the two wireless power apparatuses 100 above is defined as a first power source, and the other of the two wireless power apparatuses 100 below is defined as a second power source. A positive contact on a lower end of the first power source abuts a positive contact on an upper end of the second power source abut, and a negative contact on the lower end of the first power source abuts a negative contact on the upper end of the second power source. The uppermost wireless power apparatus 100 can provide wireless power to the equipment body 310 or provide power through the positive contact and the negative contact. The positive contact and the negative contact are disposed at an eccentric position of the wireless power apparatuses 100, not at a central position of the upper end, and this arrangement allows an electrical connection between the stacked wireless power apparatuses 100 in storage to be avoided by rotating two adjacent wireless power apparatuses 100 by 90 degrees. In this embodiment, four first magnetic pieces 130 and four second magnetic pieces 160 are provided, where an included angle between any two adjacent first magnetic pieces 130 is 90 degrees, and an included angle between any two adjacent second magnetic pieces 160 is 90 degrees.

To avoid an accidental collision in the power supply process, which may cause separation between the equipment body 310 and the wireless power apparatus 100, resulting in the end of power supply, in this embodiment, the first adsorption portion 111 has a structure of a spherical surface, which bends towards the lower end of the housing 110 in a direction away from the power supply portion 112. A central vertical line of the power supply portion 112 passes through a spherical center of the spherical surface. In another embodiment, the first adsorption portion 111 has a structure of a spherical surface, which bends towards the lower end of the housing 110 in a direction away from the power supply portion 112.0, and the second adsorption portion 113 is parallel to the first adsorption portion 111. That is, the second adsorption portion 113 is formed by biasing the first adsorption portion 111. Such configuration enables stacking of multiple housings 110. To fit the first adsorption portion 111, an end of the equipment body 310 mating with the wireless power apparatus 100 also has a structure of a spherical surface which is in a groove shape. This arrangement allows the wireless power apparatus 100 and the equipment body 310 to tend to go away from each other during the process of pushing against the wireless power supply apparatus 100 from the side. In this case, a large force is needed, avoiding separation of the equipment body 310 from the wireless power apparatus 100 due to an accidental touch. It is noted that the above-described structure does not affect the relative rotation of the wireless power apparatus 100 and the equipment body 310. In a rotating process, an adsorption force between the first magnetic piece 130 and the first adsorption piece 320 is small, and the wireless power apparatus 100 and the equipment body 310 can be easily separated from each other when the first magnetic piece 130 and the first adsorption piece 320 are completely misaligned.

In another implementation of this embodiment, the first adsorption portion 111 may have a structure of a conical surface, and the central vertical line of the power supply portion 112 passes through the vertex of the conical surface. In this implementation, the first adsorption portion 111 has a structure of a conical surface, and the second adsorption portion 113 may also have the conical surface structure. An end of the equipment body 310 mating with the wireless power apparatus 100 also has a structure of a conical surface, which is in a groove shape.

The lower end of the housing 110 includes the second adsorption portion 113 and a charging portion 114, the second adsorption portion 113 is located at an outer periphery of the charging portion 114, the first charging assembly 140 is disposed on the charging portion 114, multiple second magnetic piece 160 are provided, and the multiple second magnetic pieces 160 are dispersedly disposed on the second adsorption portion 113. The second magnetic pieces 160 are disposed to be in one-to-one correspondence with the first magnetic pieces 130 to ensure a sufficient adsorption force. On the other hand, the second magnetic pieces 160 can be adsorbed to the second adsorption pieces 240 of the charging dock 200 to ensure that the wireless power apparatus 100 is securely connected to the charging dock 200 in the power supply process. The multiple second magnetic pieces 160 are uniformly dispersed around the power supply portion 112, which allows simpler alignment of the equipment body 310 with the charging dock 200. After roughly aligning the equipment body 310 with the charging dock 200, alignment of the equipment body 310 with the wireless power apparatus 100 can be achieved through the adsorption of the multiple first magnetic pieces 160 and the second adsorption pieces 240 of the charging dock 200.

In this embodiment, four second magnetic pieces 160 and four second adsorption pieces 240 are provided, and an included angle between any two adjacent second magnetic pieces 160 is 90 degrees, and an included angle between any two adjacent second adsorption pieces 240 is 90 degrees.

The wireless power apparatus 100 includes multiple prompting assemblies for prompting at least one of a first state of charging the first battery 120, a second state of charging the equipment body 310, or a third state of a charge of the wireless power apparatus 100. In this embodiment, the prompting assembly includes an indicator light, and indicates the three states through on and off of the indicator light. A specific indication manner is not limited herein. The power apparatus 100 is provided with an operation portion 170, and the operation portion 170 can be used for controlling the on/off state of the indicator light or other functions, and particularly, the prompting assembly can be controlled by the operation portion 170 to prompt the third state.

In this embodiment, the capacity, size and other performance parameters of the first battery 120 can be set according to requirements, which are not limited herein. A charging process of the wireless power apparatus 100 is compatible with a QI protocol and an Magsafe ecological chain. The wireless power apparatus 100 can achieve the waterproof and dustproof of IP 67.

### Embodiment Two

This embodiment further provides a charging dock 200 configured to charge the wireless power apparatus 100 described above. The charging dock 200 includes a base 210, a power line 220 and a second charging assembly 230, where the base 210 is provided with a second adsorption piece 240 capable of being adsorbed to the second magnetic piece 160, one end of the power line 220 is electrically connected to a power grid, the other end of the power line 220 is electrically connected to the second charging assembly 230 disposed on the base 210, and the second charging assembly 230 can charge the first battery 120 in cooperation with the first charging assembly 140. Specifically, the second charging assembly 230 includes a positive charging terminal 231 and a negative charging terminal 232, where the positive charging terminal 231 and the negative charging terminal 232 are connected to the positive terminal 141 and the negative terminal 142, respectively.

To avoid the wireless power apparatus 100 from being separated from the charging dock 200 due to a lateral force in the power supply process, in this embodiment, the base 210 is provided with a limiting position piece located around the wireless power apparatus 100. Specifically, the limiting position piece is an annular structure surrounding the wireless power apparatus 100.

In another embodiment, a surface of the charging dock 200 that abuts the wireless power apparatus 100 includes a power portion 211 and an abutment portion 212. The abutment portion 212 is disposed around an outer periphery of the power portion 211, the abutment portion 212 has a structure of a conical surface, which is bent downward, and a central vertical line of the power portion 211 passes through a ball center of the abutment portion 212. A lower end surface of the housing 110 is shaped to fit the charging dock 200. This arrangement allows the wireless power apparatus 100 to tend to move away from the equipment body 310 when a lateral force perpendicular to the central vertical line is applied to the wireless power supply apparatus 100, and an adsorption force between the second magnetic member 160 and the second attraction member 240 needs to be overcome, improving the firmness of the connection between the wireless power apparatus 100 and the charging dock 200. In other implementations of this embodiment, the abutment portion 212 may have a structure of a conical surface, and the center vertical line L1 of the power portion 211 passes through the vertex O of the abutment portion 212. Of course, for ease of manufacturing, the conical surface of the abutment portion 212 may have a certain curvature to facilitate a smooth transition with the planar power portion 211 and a circumferential side wall of the base 210.

In this embodiment, the charging dock 200 is provided with multiple connected bases 210, each base 210 is provided with one charging stand, and each charging stand has a power portion 211 and an abutment portion 212. Each charging stand has a power light 250 to indicate whether a charging is normal.

### Embodiment Three

This embodiment further provides an electronic equipment 300. The electronic equipment 300 includes an equipment body 310 and the wireless power apparatus 100 in the embodiment one, the equipment body 310 is provided with a first adsorption piece 320 capable of being adsorbed to the first magnetic piece 130, the first battery 120 is capable of powering the equipment body 310 through the wireless power supply assembly 150. With such configuration, the equipment body 310 and the wireless power apparatus 100 may be a split structure for ease of portability, and the equipment body 310 may not be provided with a battery, which reduces the cost while reducing the mass. In this embodiment, the equipment body 310 may be a communication device, a lighting device, a cooker, a fan, or the like, where the communication device may be a mobile phone, which is not limited herein.

In camping, the lighting device, the fan or the like is difficult to hang in a proper place in a tent, and thus is inconvenient to use. In this embodiment, since the equipment body 310 and the wireless power apparatus 100 may be the split structure, so that the wireless power apparatus 100 can be placed outside the tent and the equipment body 310 is placed inside the tent to effectively secure the equipment body 310 at any location upon camping out, in this embodiment, the equipment body 310 may be a device such as a lighting device, a screen, or a fan, which is not limited herein.

In an embodiment, wireless receiving coils 330 mounted on the different equipment bodies 310 are the same, and annular adsorption pieces mounted on the different equipment bodies 310 are the same. In another embodiment, wireless receiving coils 330 mounted on different equipment bodies 310 are the same and layouts of the first adsorption pieces 320 mounted on the different equipment bodies 310 are the same. The above arrangement facilitates the layout of the ecological chain.

Of course, in other embodiments, the equipment body 310 may also be provided with the battery. Specifically, if the equipment body 310 includes a stand, and a second battery and an electronic device disposed on the stand, the second battery is configured to power the electronic device, the first battery 120 is capable of powering the second battery through the wireless power supply assembly 150 and/or directly powering the electronic device. The lighting device is used as an example, in an embodiment, the lighting device includes a stand, a second battery and a light bulb electrically connected to the second battery, where the second battery and the light bulb are both disposed on the stand, the light bulb may be defined as the electronic device, and the light bulb may be lit when the first battery 120 powers the light bulb. In a second embodiment, when the first battery 120 powers the second battery and the light bulb simultaneously, the light bulb may be lit during charging of the second battery. In a third embodiment, the light bulb may or may not be lit when the second battery powers the first battery 120.

In this embodiment, the wireless power apparatus 100 may carry the equipment body 310. The arrangement enables the equipment body 310 to use the wireless power apparatus 100 as the base 210, thereby reducing the footprint.

Obviously, the above embodiments of the present disclosure are merely examples for clearly illustrating the present disclosure and are not intended to limit the embodiments of the present disclosure. For those of ordinary skill in the art, other variations and modifications in different forms may be made in light of the above description. This need not be, nor should it be exhaustive of all embodiments.

What is claimed is:

1. A wireless power apparatus, comprising:
a housing, which is provided with a mounting cavity;
a first battery, which is disposed within the mounting cavity;
a plurality of first magnetic pieces, which are disposed in the housing;
a first charging assembly, which is configured to charge the first battery; and
a wireless power supply assembly, which is disposed within the mounting cavity and electrically connected to the first battery.

2. The wireless power apparatus of claim 1, wherein an upper end surface of the housing comprises a first adsorption portion and a power supply portion, the first adsorption portion is located at an outer periphery of the power supply portion, the wireless power supply assembly is disposed on the power supply portion, and the plurality of first magnetic pieces are dispersedly disposed on the first adsorption portion.

3. The wireless power apparatus of claim 2, wherein a lower end of the housing is provided with a plurality of second magnetic pieces, and wherein in a case where two housings are stacked, second magnetic pieces on an upper one of the two housings are capable of being adsorbed to second magnetic pieces on a lower one of the two housings correspondingly.

4. The wireless power apparatus of claim 3, wherein in a case where a plurality of housings are stacked, a plurality of first batteries are connected in series.

5. The wireless power apparatus of claim 3, wherein the lower end of the housing comprises a second adsorption portion and a charging portion, the second adsorption portion is located at an outer periphery of the charging portion, the first charging assembly is disposed on the charging portion, and the plurality of second magnetic pieces are dispersedly disposed on the second adsorption portion.

6. The wireless power apparatus of claim 5, wherein the first adsorption portion has a structure of a conical surface; or
the first adsorption portion has a structure of a conical surface, and the second adsorption portion is parallel to the first adsorption portion.

7. A charging dock, wherein the charging dock is configured to charge the wireless power apparatus of claim 1, a lower end of the housing of the wireless power apparatus is provided with a second magnetic piece, the charging dock comprises a base and a second charging assembly, wherein the base is provided with a second adsorption piece capable of being adsorbed to the second magnetic piece, and the second charging assembly is capable of charging the first battery in cooperation with the first charging assembly.

8. The charging dock of claim 7, wherein a surface of the base that abuts the wireless power apparatus comprises a power portion and an abutment portion, the abutment portion is disposed around an outer periphery of the power portion, the abutment portion has a structure of a conical surface; and a lower end surface of the housing is shaped to fit the base.

9. An electronic equipment, comprising the wireless power apparatus of claim 1 and an equipment body, wherein the equipment body is provided with a first adsorption piece capable of being adsorbed to a first magnetic piece of the wireless power apparatus, and the first battery is capable of powering the equipment body through the wireless power supply assembly.

10. The electronic equipment of claim 9, wherein the equipment body comprises a second battery and an electronic device, wherein the second battery is configured to power the electronic device, the first battery is capable of powering at least one of the second battery or the electronic device through the wireless power supply assembly.

11. A charging dock, wherein the charging dock is configured to charge the wireless power apparatus of claim 2, a lower end of the housing of the wireless power apparatus is provided with a second magnetic piece, the charging dock comprises a base and a second charging assembly, wherein the base is provided with a second adsorption piece capable of being adsorbed to the second magnetic piece, and the second charging assembly is capable of charging the first battery in cooperation with the first charging assembly.

12. A charging dock, wherein the charging dock is configured to charge the wireless power apparatus of claim 3, a lower end of the housing of the wireless power apparatus is provided with a second magnetic piece, the charging dock comprises a base and a second charging assembly, wherein the base is provided with a second adsorption piece capable of being adsorbed to the second magnetic piece, and the second charging assembly is capable of charging the first battery in cooperation with the first charging assembly.

13. A charging dock, wherein the charging dock is configured to charge the wireless power apparatus of claim 4, a lower end of the housing of the wireless power apparatus is provided with a second magnetic piece, the charging dock comprises a base and a second charging assembly, wherein the base is provided with a second adsorption piece capable of being adsorbed to the second magnetic piece, and the second charging assembly is capable of charging the first battery in cooperation with the first charging assembly.

14. A charging dock, wherein the charging dock is configured to charge the wireless power apparatus of claim 5, a lower end of the housing of the wireless power apparatus is provided with a second magnetic piece, the charging dock comprises a base and a second charging assembly, wherein the base is provided with a second adsorption piece capable of being adsorbed to the second magnetic piece, and the second charging assembly is capable of charging the first battery in cooperation with the first charging assembly.

15. A charging dock, wherein the charging dock is configured to charge the wireless power apparatus of claim 6, a lower end of the housing of the wireless power apparatus is provided with a second magnetic piece, the charging dock comprises a base and a second charging assembly, wherein the base is provided with a second adsorption piece capable of being adsorbed to the second magnetic piece, and the second charging assembly is capable of charging the first battery in cooperation with the first charging assembly.

16. An electronic equipment, comprising the wireless power apparatus of claim 2 and an equipment body, wherein the equipment body is provided with a first adsorption piece capable of being adsorbed to a first magnetic piece of the wireless power apparatus, and the first battery is capable of powering the equipment body through the wireless power supply assembly.

17. An electronic equipment, comprising the wireless power apparatus of claim 3 and an equipment body, wherein the equipment body is provided with a first adsorption piece capable of being adsorbed to a first magnetic piece of the wireless power apparatus, and the first battery is capable of powering the equipment body through the wireless power supply assembly.

18. An electronic equipment, comprising the wireless power apparatus of claim 4 and an equipment body, wherein the equipment body is provided with a first adsorption piece capable of being adsorbed to a first magnetic piece of the wireless power apparatus, and the first battery is capable of powering the equipment body through the wireless power supply assembly.

19. An electronic equipment, comprising the wireless power apparatus of claim 5 and an equipment body, wherein the equipment body is provided with a first adsorption piece capable of being adsorbed to a first magnetic piece of the wireless power apparatus, and the first battery is capable of powering the equipment body through the wireless power supply assembly.

20. An electronic equipment, comprising the wireless power apparatus of claim 6 and an equipment body, wherein the equipment body is provided with a first adsorption piece capable of being adsorbed to a first magnetic piece of the wireless power apparatus, and the first battery is capable of powering the equipment body through the wireless power supply assembly.
